(19) United States
(12) Patent Application Publication
(10) Pub. No.: US 2015/0127287 A1
(43) Pub. Date: May 7, 2015

(54) DETERMINING CALIBRATED MEASUREMENTS OF PRESSURE FOR DIFFERENT SENSORS

(71) Applicant: NextNav, LLC, Sunnyvale, CA (US)

(72) Inventors: Thomas Wolf, Mountain View, CA (US); Michael Dormody, Sunnyvale, CA (US)

(21) Appl. No.: 14/527,041

(22) Filed: Oct. 29, 2014

Related U.S. Application Data
(60) Provisional application No. 61/899,846, filed on Nov. 4, 2013.

(51) Int. Cl. G01L 27/00; G01K 19/00

(52) U.S. Cl. CPC G01L 27/005; G01K 19/00
USPC 702/98

(57) ABSTRACT

Systems and methods for calibrating individual pressure sensors using mathematical models to compensate for inaccurate measurements of pressure from those pressure sensors are described. Also described are systems and methods for applying those mathematical models to adjust measurements from those pressure sensors during position computations.

### FIELD

This disclosure relates generally to positioning systems. More specifically, but not exclusively, the disclosure relates to systems and methods for determining calibration models associated with different sensors, and for using those calibration models to compute positions of the sensors.

### BACKGROUND

Positioning systems and methods like those used in relation to satellite or terrestrial transmitter networks have been widely used to determine position information for mobile computing devices like smart phones. However, many of these systems and methods do not deliver the accuracy needed to determine an exact location of the device. For instance, if the device is in a multi-story building, not knowing the floor or altitude at which the device resides will result in delays in providing emergency assistance, which could be potentially life-threatening. As described in U.S. patent application Ser. No. 13/296,067 (filed Nov. 14, 2011), techniques for estimating an altitude of a device may use measurements of pressure at the device. These measurements may be obtained from low-cost MEMS sensors that are incorporated into the device. In many cases, these low-cost MEMS sensors have precision that is comparable to calibration instruments, but the sensors provide measurements that lack accuracy needed for reliable altitude computations.

Many pressure sensors, for example, provide measurements with errors that could result in an estimated altitude of a device that differs from the device's actual location by two or more floors. This reduced accuracy is unacceptable in various situations, including emergency response activities that rely on floor-level accuracy to reach users as quickly as possible. Thus, sensors ideally must be calibrated to reduce such error.

Unfortunately, the same amount of calibration cannot be used for each sensor, since sensors of the same model that are manufactured by the same manufacturer often provide different measurements of the same environmental condition (e.g., atmospheric pressure). Consequently, different calibration is often needed on a sensor-by-sensor basis.

To make matters more complicated, a single sensor may perform differently under different environmental conditions. For example, different levels of temperature may affect the performance of a pressure sensor. As a consequence, different calibration may be needed for the same sensor depending on environmental conditions.

Clearly, systems and methods that determine how to calibrate a pressure sensor and that use the calibration(s) would improve estimations of the sensor's altitude. Fortunately, this disclosure describes various embodiments of such systems and methods, which are also useful for other types of sensors beyond pressure sensors.

### SUMMARY

This disclosure relates generally to positioning systems. More specifically, but not exclusively, the disclosure relates to systems (networks, devices, or components), methods, means, and machine-readable media embodying program instructions adapted to be executed by systems to implement methods for determining calibration models associated with different sensors, and for using those calibration models.

Some aspects of the disclosure relate to calibration systems and methods that are configured to identify operating parameters of a sensor like a temperature range and a pressure range. The calibration systems and methods may be further configured to, for each of a plurality of different temperature and pressure combinations within the operating parameters, identify reported measurements of pressure from a sensor when the sensor is stabilized to each combination of temperature and the pressure; and compute a pressure measurement error based on a comparison of a calibrated measurement of the pressure and the reported measurement. The calibration systems and methods may also or alternatively be configured to select a mathematical model that sufficiently fits the computed pressure measurement errors as a function of the reported measurement of pressure and a measurement of temperature, and store a pressure measurement error function based on the mathematical model for later use in adjusting pressure measurements from the sensor.

Additional aspects of the disclosure relate to systems and methods that are configured to use the pressure measurement error function to estimate a pressure measurement error associated with a measured pressure by the sensor during its use in a mobile computing device. The systems and methods may then adjust the measured pressure by the pressure measurement error to obtain an adjusted pressure measurement for use in determining an altitude of the sensor.

Additional aspects are described below in conjunction with the Drawings, Detailed Description and Claims.

### BRIEF DESCRIPTION OF THE DRAWINGS

FIG. 1 depicts a positioning network.

FIG. 2 depicts a transmitter.

FIG. 3 depicts a user device.

FIG. 4 depicts a calibration system for determining how to calibrate a sensor by estimating measurement error associated with a pressure sensor.

FIG. 5 illustrates a process for generating a function that estimates measurement error associated with a type of sensor under various operational conditions.

FIG. 6 illustrates a process for generating a function that estimates measurement error associated with a pressure sensor under various operational conditions associated with temperature and pressure.

FIG. 7 shows a plot of observed pressure measurement errors at different combinations of temperature and pressure.

FIG. 8 shows a plot of a mathematical model's fit to observed pressure measurement error.

FIG. 9 shows a plot of residual error associated with observed pressure measurement errors and estimated pressure measurement errors.

### DETAILED DESCRIPTION

### Example Systems

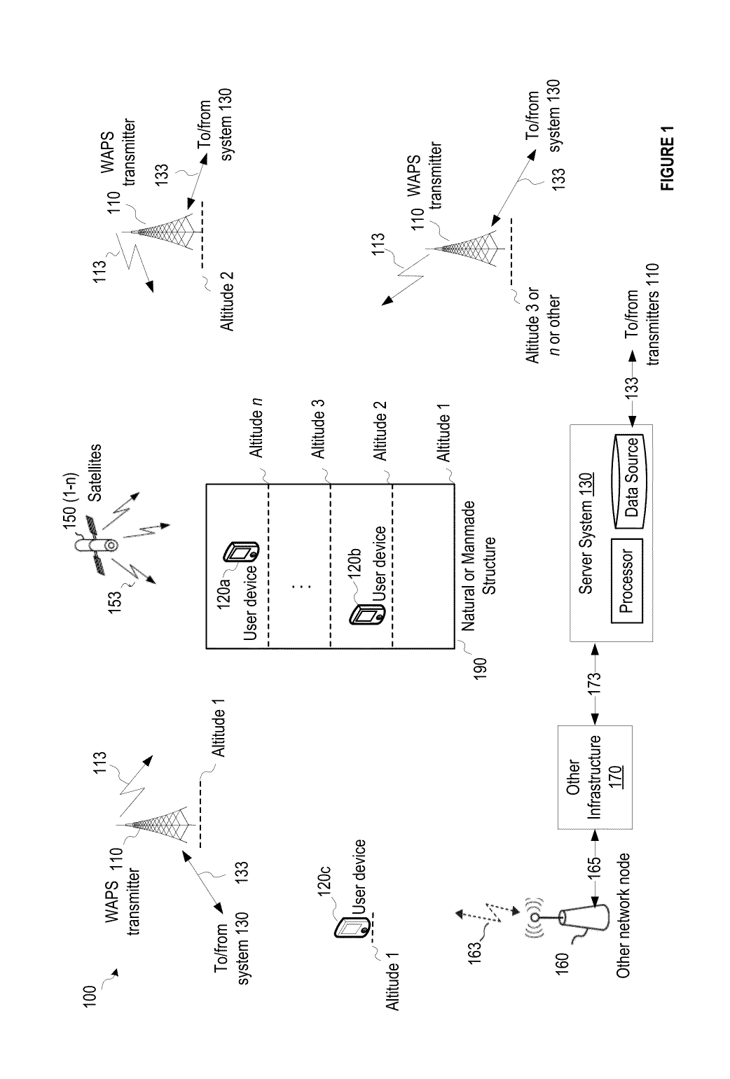

FIG. 1 depicts a positioning network 100 on which various embodiments may be implemented. The positioning network 100 includes a network of synchronized transmitters 110 (also denoted herein as “beacons” or “towers”), which are depicted as terrestrial, as well any number of user devices 120 configured to acquire and track signals provided from the transmitters 110, satellites 150, and/or another terrestrial node 160. The user device 120 may include a location computation engine (not shown) to determine position information based on the signals received from the transmitters 110. The network 100 may further include a server system 130 that includes a processor and database, and that is in communication with various other systems, such as the transmitters 110, the user devices 120, and one or more network infrastructures 170 (e.g., the Internet, other networks). Three user devices 120a-c are depicted at various altitudes; however, the network 100 would typically be configured to support more user devices 120 at more altitudes within a defined coverage area. The user devices 120 may receive/send signaling via communication links 113, 153 and 163.

### Transmitters

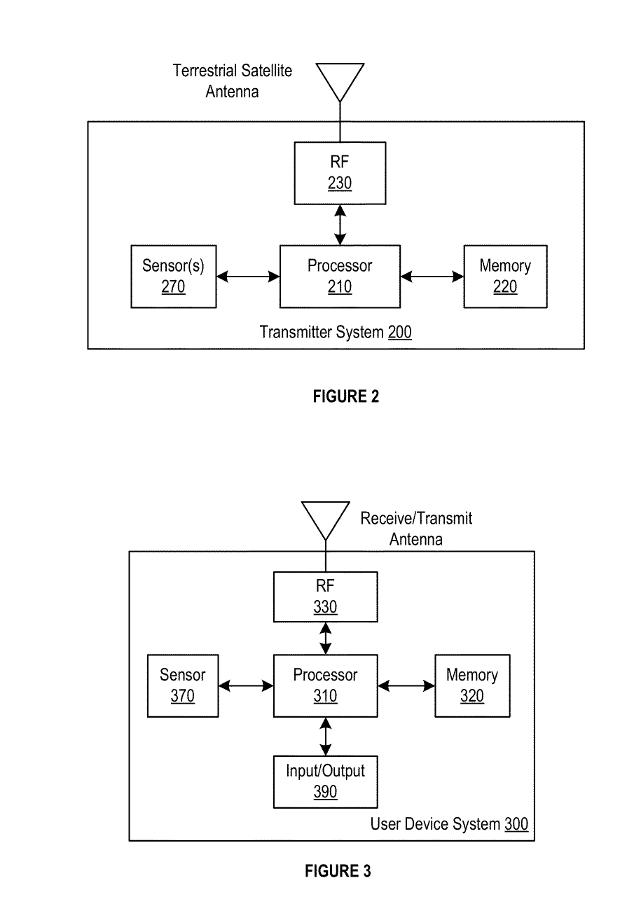

Details of one embodiment of the transmitter 110 are shown in FIG. 2. As shown, the transmitter 200 sends, receives and processes signals via an RF component 230. Memory 220 may be coupled to a processor 210 to provide storage and retrieval of instructions relating to described methods that may be executed by the processor 210. The transmitter 200 includes one or more environmental sensors 270 for measuring environmental conditions like pressure, temperature, humidity, and/or other environmental conditions. As described later, measured conditions can be used to estimate an altitude of the user device 120 so long as the measurements by the sensors 270, along with measurements by sensors at the user device 120, are accurate.

### User Device

Details of one embodiment of the user device 120 are shown in FIG. 3. As shown, the user device 300 sends, receives and processes signals via an RF component 330. Memory 320 may be coupled to a processor 310 to provide storage and retrieval of instructions relating to described methods that may be executed by the processor 310. Inputs/outputs 390 are provided to receive input from a user and to provide output to the user.

The user device 300 also includes one or more environmental sensors 370 for measuring environmental conditions like pressure, temperature, humidity, acceleration, direction of travel, and/or other conditions. Pressure measured by the environmental sensors 370, along with pressure measured by the transmitter 200, may be used by the processor 310 to estimate an altitude of the user device 300.

Various methods for using pressure to estimate an altitude of a user device 120 are disclosed in co-owned U.S. patent application Ser. No. 13/296,067, filed Nov. 14, 2011. For example, atmospheric pressure is related to elevation by a hypsometric equation:

$${z}_{2} - {z}_{1} = \frac{RT}{g} ln ( \frac{{p}_{1}}{{p}_{2}} ) ,$$

where p₁ is the atmospheric pressure at the elevation z₁, and p₂ is the atmospheric pressure at elevation z₂. R is the gas constant of air, T is the temperature, and g is the acceleration due to gravity. Thus, if the air temperature is known, and the sea level pressure, p₁, is known, one can set z₁ to zero and compute the elevation z₂ above sea level, which corresponds to any measured pressure p₂. This formulation assumes that the temperature does not vary with elevation.

A barometric formula assumes that the temperature decreases linearly with elevation:

$$p = {{p}_{0} ( 1 - \frac{Lh}{{T}_{0}} )}^{\frac{g}{RL}} ,$$

where p is the pressure at an elevation h, given the pressure and temperature at sea level, p₀ and T₀, and the lapse rate L (change in temperature per unit height). The above and other equations may be used to compute an estimate of a sensor's altitude.

One of ordinary skill in the art will appreciate that accurate pressure and temperature measurements by sensors at the transmitter 200 and the user device 300 are necessary for an accurate altitude computation. Thus, there is a need to calibrate at least the pressure sensor at the user device 300, and possibly the pressure sensor at the transmitter 200. Fortunately, this disclosure describes processes for calibrating pressure sensors.

### Calibrating Sensors

In order to better understand various aspects of this disclosure, it is noted that sensors used in user devices 120 may not always output accurate measurements. In some cases, the measurements may not be sufficiently accurate for the intended use of the measurements.

It is also noted that two sensors of the same model, and manufactured under nearly identical circumstances, may output different measurements under the same environmental conditions. For example, two such pressure sensors, when occupying nearly the same location in a building at the same time, may measure different pressures.

In order to estimate the pressure at a location of a user device 120 with sufficient accuracy, it is important to estimate the difference between the actual pressure at that location and the measurement of that pressure by a pressure sensor of the user device 120. If the difference between actual pressure and measured pressure can be estimated with sufficient accuracy, then a more-accurate assessment of the pressure can be made by increasing or decreasing the pressure measurement using the estimated difference. This more-accurate assessment of the pressure can be used to estimate the altitude of the user device with more accuracy as compared to using the unadjusted measurement of pressure from the pressure sensor. By comparison, the measurement of the pressure by the pressure sensor may fall within 200 Pa of the actual pressure, and the more-accurate assessment of the pressure may fall within 50 Pa or even 10 Pa of the actual pressure.

One approach for estimating the difference between actual pressure and measured pressure uses a mathematical model of the difference between actual and measured pressures as a function of temperature and pressure. The mathematical model may be based on comparisons of actual pressure to measured pressure when the pressure sensor is stabilized to different combinations of temperature and pressure that are selected from a range of temperatures and a range of pressures. The number of combinations may vary depending on the level of accuracy desired when applying the mathematical model.

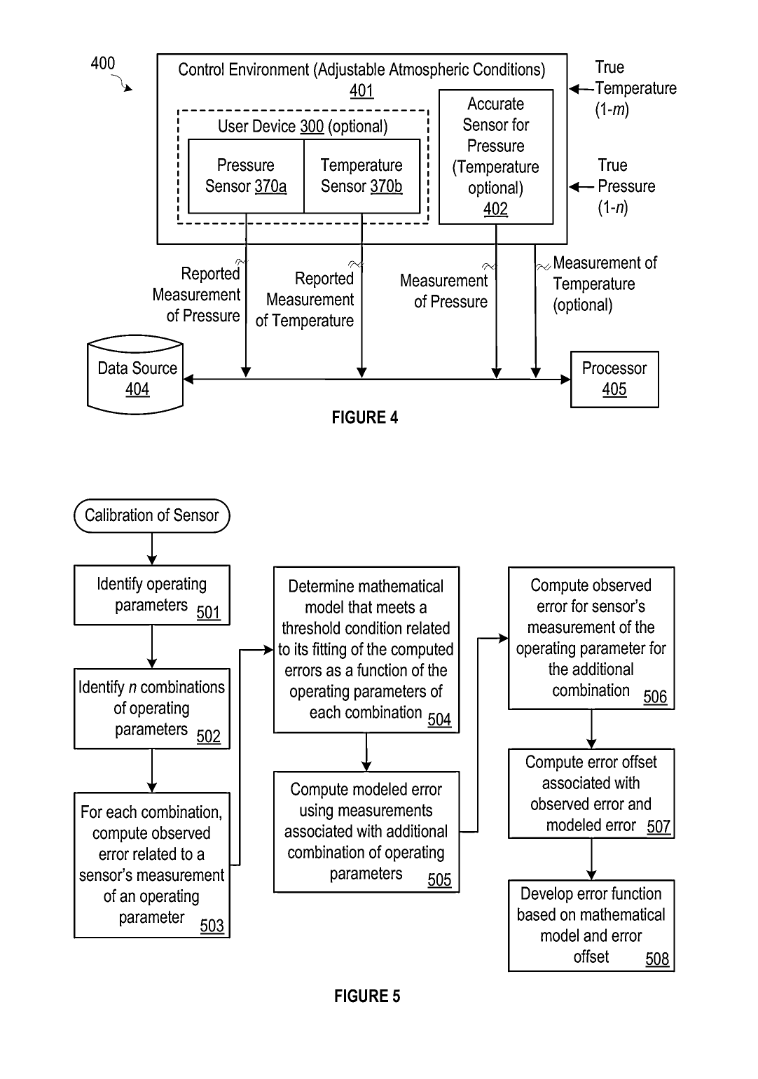

FIG. 4 depicts a calibration system 400 for generating such a mathematical model that estimates pressure measurement error associated with a particular pressure sensor. The system 400 includes an environment 401 within which different temperatures (1-m) and different pressures (1-n) are inputted. A pressure sensor 370a and a temperature sensor 370b are shown as integrated into a user device 300. It is to be understood that the sensors 370a and 370b may alternatively be tested within environment 401 without being integrated into the user device 300, and the sensors 370a and 370b may be integral to each other, coupled to each other, or independent of each other.

As shown, the environment 401 may include the pressure sensor 370a, the temperature sensor 370b, and a calibration instrument 402 that is capable of measuring pressure with desired accuracy. Alternatively, another calibration instrument (not shown) that is capable of measuring temperature with desired accuracy may be used along with, or instead of the temperature pressure sensor 370b when the temperature sensor 370b is known to output temperature measurements that are within a tolerated error from true temperature.

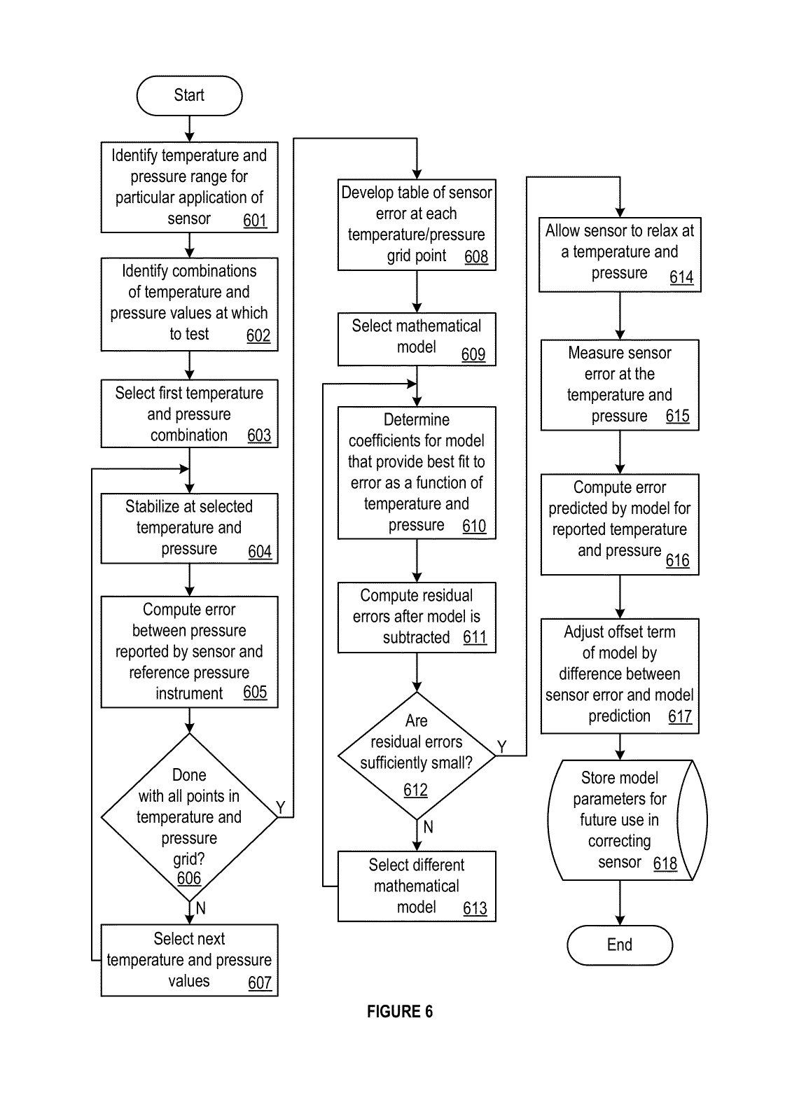

Measurements from each of the pressure sensor 370a, the temperature sensor 370b, and the calibration instrument 402 may be output, stored by a data source 404, and used by a processor 405 to perform various methods described herein, including the methods described below in relation to FIG. 5 and FIG. 6. Different measurements from the pressure sensor 370a, the temperature sensor 370b, and the calibration instrument 402 may be output depending on the number of adjustments made to the temperature and pressure within the environment 401.

Attention is now turned to FIG. 5, which illustrates a process for generating a mathematical model that estimates measurement error associated with a particular sensor (e.g., sensor 370a). The process of FIG. 5 may be used for a sensor of any type (e.g., sensors that measure pressure, temperature, humidity, motion, vibration, direction, light, air movement, time, proximity to other things, and other conditions). Examples, however, are provided in relation to pressure sensors; however, these examples should in no way limit the disclosure of the process in FIG. 5 to a pressure sensor.

As illustrated in FIG. 5, operating parameters associated with expected operating conditions of the sensor are identified (501). The operating parameters identify environmental variables under which the sensor may operate. For example, sets or ranges of temperature and pressure may be specified.

Other variables are contemplated for other implementations of the method in FIG. 5, including humidity, vibration applied to the sensor, wind velocity, ambient light, and age of a sensor. Correlation between each of variables and accurate sensor measurements are contemplated where the correlated relationship can be used to determine adjustments to sensor measurements. For example, aging of a sensor or vibration on a sensor, as those conditions affect a pressure measurement accuracy of the sensor, can be recorded and used to adjust pressure measurements based on the age of the sensor or a vibrational input (e.g., from an accelerometer) during operation of the sensor.

Any set or range may be determined based on expected operating conditions of the sensor while in use by a user. For example, a range of temperatures and a range of pressures may be determined by minimum and maximum temperatures and pressures a typical user will experience while operating the pressure sensor.

Multiple combinations of the operating parameters are identified (502) from the ranges of temperature and pressure. The sensor may then operate under each combination of the operating parameters, during which one or more recorded values of measurements from the sensor are stored.

Each measurement may be compared to a corresponding measurement taken by a calibration instrument (e.g., the calibration instrument 402). During the comparison of the measurements, the difference between each of the sensor's measurements and corresponding measurements made by the calibration instrument is determined. This difference represents an observed error of the sensor's measurement (503). For example, the pressure sensor 370a may operate under different combinations of temperature and pressure, and measurements of pressure by the pressure sensor 370a may be compared to corresponding measurements from the calibration instrument 402.

A measurement corresponding to the other initial parameter may also be recorded with respect to each combination of the operating parameters. For example, the temperature sensor 370b may also operate under the different combinations of temperature and pressure, and measurements of temperature by the temperature sensor 370b may be associated with a corresponding pressure measurement and observed error of the pressure measurement.

Once a set of observed errors is determined, one or more mathematical models may be generated to fit the observed errors as a function of the recorded values. Possible mathematical models include polynomial, trigonometric, spline, exponential, and other mathematical model families. Other models may include dividing the ranges of operating parameters into smaller sub-ranges, and then using different mathematical models in different sub-ranges, or applying a first mathematical model and then using a second mathematical model to model the residual error of the first mathematical model after it is applied to one or more combinations of operating parameters.

A mathematical model may be selected based on different considerations (504). For example, the model that best fits the observed errors may be selected. Alternatively, a model with a minimum amount of residuals that meet a threshold condition (e.g., are less than 10 Pa, 20 Pa, 50 Pa, or another amount) may be selected. The minimum amount may be specified by: a predefined percentage of all residuals; a total of all residuals within sub-ranges of the operating parameters; a higher percentage of residuals as compared to a corresponding percentage of residuals for another mathematical model; or other approaches for specifying the minimum amount. Alternatively, an average of residuals may be required to meet the threshold condition above. In addition, it may be required that the largest residual of the averaged residuals falls below another threshold value.

Once a suitable mathematical model is selected, an offset associated with modeled error and observed error may be determined. In one implementation, an additional measurement is taken from the sensor during its operation under a combination of the operating parameters. The sensor's measurement of a first parameter and a measurement of the second parameter may be used as inputs for the mathematical model to produce the modeled error (505). The sensor measurement of the first parameter is compared to an accurate measurement of the first parameter, and a difference between the sensor measurement and the accurate measurement is computed to determine the observed error (506). The offset may then be determined based on the difference between the modeled error and the observed error (507).

Optionally, the process of determining an offset may be repeated under other combinations of operating parameters to produce corresponding offsets. All of the offsets may then be used to determine a final offset value. The final offset value may be an average, weighted average, or other combination of the individual offsets (or a sub-set of the offsets) depending on the individual combinations tested.

Once a final offset is determined, an error function may be developed based on the mathematical model and the offset (508). In one implementation, the offset is added to the zero order term of the mathematical model.

Of course, the error function may be based on the mathematical model, but not the offset. In one implementation, a lookup table may be used to identify an offset depending on measurements from one or more sensors—e.g., pressure and/or temperature during operation of pressure and/or temperature sensors. That offset may then be used to determine a more-accurate sensor measurement. Such an adjustment to the measurement may be made to the initial measurement before the error function is applied to that offset-adjusted measurement. Alternatively, the error function may be applied to the initial measurement to determine an error-function-adjusted measurement, and then the offset may be applied to that error-function-adjusted measurement.

It is noted that the error function may use different offsets depending on different inputs into the function (e.g., temperatures within a sub-range of temperatures, pressures within a sub-range of pressures).

The previous examples related to FIG. 5 involving temperature and pressure as evaluated parameters should also in no way limit the disclosure to two evaluated parameters. It is contemplated that any number of parameters can be evaluated, including one parameter, or more than two parameters. Measurements for a corresponding number of sensors are contemplated, including one sensor for one parameter of evaluation, three sensors for three parameters of evaluation, and so on.

### Calibrating Pressure Sensor

Attention is now drawn to FIG. 6, which illustrates a process for generating a mathematical model that estimates pressure measurement error associated with a pressure sensor 370a under various operational conditions.

Initially, temperature and pressure ranges are identified for an expected use of the sensor (601). The expected use may define typical, expected or possible operating temperatures and pressures for the pressure sensor 370a when integrated into a user device 300. In one implementation, the environmental conditions include a pressure range of 72,000-107,000 Pa, and a temperature range of 0-60° C. The temperature range spans 0-60° C. when expected ambient operating temperatures are 0-40° C. and expected internal operating temperatures of a user device 300 exceed ambient operating temperature by up to 20° C.

A group of different temperature and pressure combinations are also identified (602). The combinations may be spaced by 10° C. increments in temperature and 5,000 Pa increments in pressure. Thus, there could be seven temperature steps and eight pressure steps, which result in 56 combinations of temperature and pressure. Alternative increments are possible depending on the number of test combinations desired and the ranges of temperature and pressure tested. In regions where error varies slowly, some combinations may be omitted from analysis of the ranges or within sub-ranges of temperature and pressure. In regions where the error varies rapidly, additional combinations may be inserted across the ranges or within sub-ranges of temperature and pressure. The combinations may form a grid of temperature (T) and pressure (P) combinations.

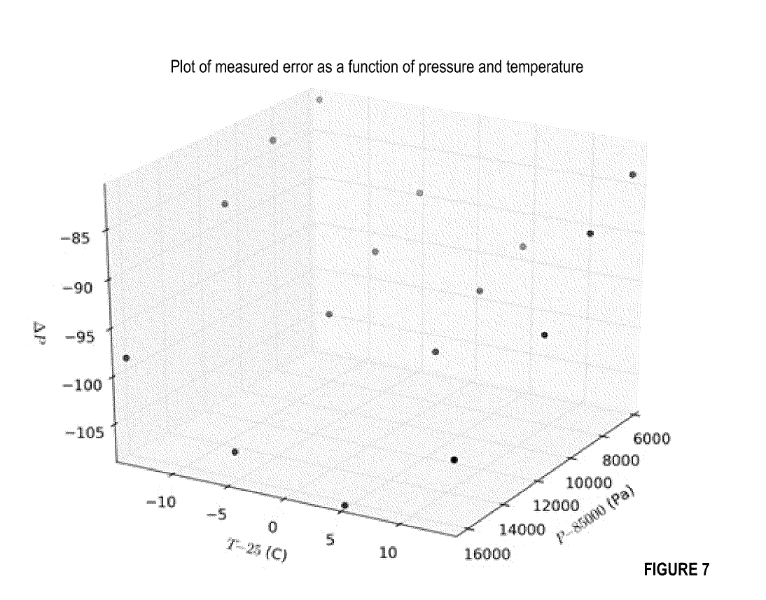

As shown by steps 603-607 of FIG. 6, the pressure sensor 370a and the temperature sensor 370b may be stabilized to each of the combinations of temperature and pressure, at which reported measurements may be obtained from the pressure sensor 370a and the temperature sensor 370b. The calibration instrument 402 may also provide an accurate measurement of the pressure. An accurate measurement of the temperature may optionally be determined. The difference between the reported measurement of pressure and the accurate measurement of pressure may then determine the observed error of the reported pressure measurement for each of the combinations of temperature and pressure. By way of example, FIG. 7 shows a plot of observed pressure measurement errors at different combinations of temperature and pressure. The observed errors and reported measurements of pressure and temperature are stored (608). Multiple measurements can be made at different times for the same combinations, and those measurements may be averaged or otherwise combined.

A mathematical model is then selected to fit the observed error as a function of reported pressure and temperature (609). Coefficients for the model that provide the best fit to error as a function of temperature and pressure are determined (610), and residual errors are computed after the model is subtracted (611). If the values of residuals are not desired (612), a new mathematical model is selected (613), and steps 610-612 are repeated for that new mathematical model.

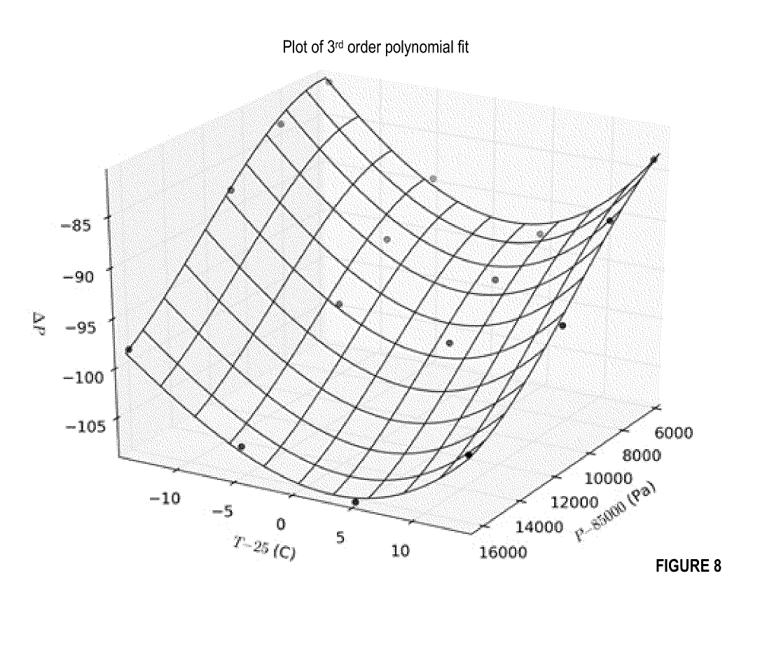

By way of example, FIG. 8 shows a plot of a mathematical model's fit to the observed pressure measurement error. By way of example, the mathematical model may include a third order polynomial model wherein the observed error (E) is given by:

$$E = a \times {p}^{3} + b \times t \times {p}^{2} + c \times p \times {t}^{2} + d \times {t}^{3} + e \times {p}^{2} + f \times p \times t + g \times {t}^{2} + h \times p + i \times t + j$$

where t and p are temperature and pressure, and a through j are constants that are determined to provide the best fit of observed error to the reported measurements.

By way of example, another mathematical model may include a third order polynomial model wherein the observed error (E) is given by:

$$E = a \times {( p - {p}_{0} )}^{3} + b \times ( t - {t}_{0} ) \times {( p - {p}_{0} )}^{2} + c \times ( p - {p}_{0} ) \times {( t - {t}_{0} )}^{2} + d \times {( t - {t}_{0} )}^{3} + e \times {( p - {p}_{0} )}^{2} + f \times ( p - {p}_{0} ) \times ( t - {t}_{0} ) + g \times {( t - {t}_{0} )}^{2} + h \times ( p - {p}_{0} ) + i \times ( t - {t}_{0} ) + j$$

where (t−t₀) and (p−p₀) are the measured temperatures and pressures offset by a constant temperature t₀ and a constant pressure p₀, respectively, and a through j are constants that are determined to provide the best fit of observed error to the reported measurements. t₀ and p₀ are selected to aid in the fitting of the mathematical model.

If the polynomial model does not provide a desired fit, different polynomial coefficients may be used for different regions of the overall temperature-pressure test space. For example, one set of coefficients for temperatures above 0° C. and a different set of coefficients for temperatures below 0° C. may be used. Alternatively, different mathematical models may be used for different temperatures.

A particular mathematical model may be selected when its residuals meet a threshold condition. Examples of threshold conditions in relation to a minimum amount of residuals have been described previously.

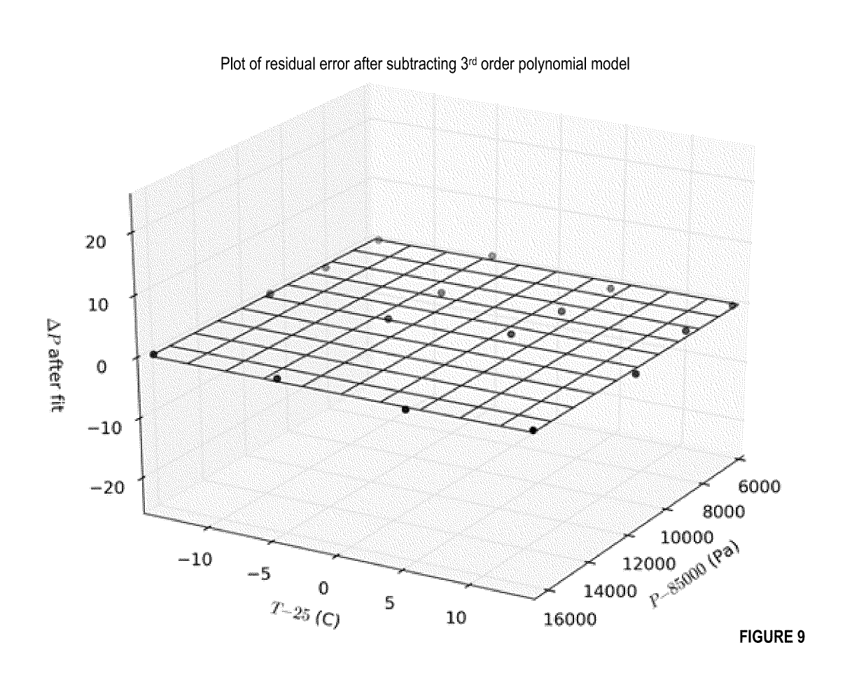

By way of example, FIG. 9 shows a plot of residual error associated with the difference between the observed value and estimated value of error at each of the combinations of reported pressure and temperature.

Once a mathematical model is selected, the pressure sensor 370a and the temperature sensor 370b are stabilized to a control temperature and pressure (614). The control temperature may be within x % (e.g., 10%) of standard room temperature (˜21-23 degrees C.), or typical internal operating temperature of the user device 300 in a room temperature environment. Reported pressure and temperature measurements from the pressure and temperature sensors 370a and 370b, an accurate measurement of pressure from the calibration instrument 402, and (optionally) an accurate measurement of the temperature, are recorded for the control temperature and pressure. The observed error of the pressure sensor 370a is determined based on the difference between the reported measurement and the accurate measurement of pressure (615). A modeled error is also determined by inputting the reported measurements into the mathematical model (616). The observed error and modeled error are then compared to determine an offset based on the difference between the observed and modeled errors (617).

Alternatively, a previously measured temperature and pressure may be used instead of the control temperature and pressure to determine the offset.

The offset, along with the mathematical model, are then stored as model parameters for future use in adjusting measurements from the sensor 370a (618). The storage may occur at the data source 404 of FIG. 4, the server system 130 of FIG. 1, the memory 320 of the user device 300 of FIG. 3, or another component.

The model parameters may be accessed by a processor when computing an altitude of the user device 300 based on a measurement of pressure from the pressure sensor 370a. Such a processor may include the processor 310 of the user device 300, a processing component of the server system 130, or another processing component.

The model parameters may define a pressure measurement error function that can be used to estimate the measurement error from the pressure sensor 370a under particular environmental conditions. The estimated error may be added or subtracted from the reported pressure measurement to obtain a more accurate estimate of true pressure.

One of skill in the art will readily extend the discussion herein regarding pressure sensors to other sensors, including temperature, humidity, and any other sensor known or later-developed in the art.

One of skill will also recognize that similar, but different combinations of operating parameters may be used during different implementations of the calibration process, depending on the appropriate environment for the sensor operation. For example, during one application of the calibration process, a temperature of 30° C. may be used with pressures of 72,000 Pa, 81,000 Pa, and 100,000 Pa. During another implementation of the calibration process, a temperature of 32° C. may be used with those same pressures or slightly different pressures. During yet another implementation of the calibration process, a temperature of 30° C. may be used with slightly different pressures than 72,000 Pa, 81,000 Pa, and 100,000 Pa. However, varying the combinations across different implementation of the calibration process corresponding to different sensors is acceptable since the objective is to individually test different sensors. It is also contemplated that multiple implementations of the calibration process may be performed on the same sensor, and the resultant mathematical models may be compared to select the best function, or each result from the functions may be averaged or otherwise combined to improve the more-accurate assessment of the sensor's measurement.

It is also contemplated that calibration may occur using historical data where accurate measurements of an environmental condition may be compared to measurements of that environmental condition by a sensor during the same time or close in time. It is further contemplated that measurements of an environmental condition (e.g., pressure) by a sensor and calibration device may not occur at the same location (e.g., for the purpose of determining an offset), but rather two locations with similar levels of the environmental condition.

### Additional Embodiments of Systems and Methods

Functionality and operation disclosed herein may be embodied as one or more methods implemented, in whole or in part, by machine(s)—e.g., processor(s), computers, or other suitable means known in the art—at one or more locations, which enhances the functionality of those machines, as well as computing devices that incorporate those machines. Non-transitory machine-readable media embodying program instructions adapted to be executed to implement the method(s) are also contemplated. Execution of the program instructions by one or more processors cause the processors to carry out the method(s).

It is noted that method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time.

By way of example, method(s) and processor(s) may: identify operating parameters, wherein the operating parameters include a temperature range and a pressure range.

By way of example, method(s) and processor(s) may also or alternatively: for each of a plurality of different temperature and pressure combinations that use temperatures within the temperature range and pressures within the pressure range, identify a reported measurement of pressure from a first sensor when the first sensor is stabilized to the temperature and the pressure of that combination, and compute a pressure measurement error based on a comparison of a calibrated measurement of the pressure and the reported measurement.

By way of example, method(s) and processor(s) may also or alternatively: select a mathematical model, from a plurality of mathematical models, that sufficiently fits the computed pressure measurement errors as a function of the reported measurement of pressure and a measurement of temperature corresponding to each of the temperature and pressure combinations.

By way of example, method(s) and processor(s) may also or alternatively: store a pressure measurement error function based on the mathematical model for later use in calibrating pressure measurements from the first sensor.

By way of example, method(s) and processor(s) may also or alternatively: identify an additional reported measurement of pressure from the first sensor when the first sensor is stabilized to a control temperature and a control pressure.

By way of example, method(s) and processor(s) may also or alternatively: compute a control pressure measurement error based on a comparison of the additional reported measurement and a calibrated measurement of the control pressure.

By way of example, method(s) and processor(s) may also or alternatively: compute a modeled pressure measurement error based on the mathematical model using model inputs that are based on the reported measurement of the control pressure from the first sensor and a measurement of the control temperature.

By way of example, method(s) and processor(s) may also or alternatively: determine a pressure measurement error offset based on a difference between the modeled pressure measurement error and the control pressure measurement error.

By way of example, method(s) and processor(s) may also or alternatively: store the pressure measurement error function based further on the pressure measurement error offset.

In accordance with some aspects, the control temperature is within 10% of a twenty-five degrees Celsius.

In accordance with some aspects, the plurality of different temperature and pressure combinations are selected so that any reported pressure measurement from the first sensor at a temperature within the temperature range and a pressure within the pressure range will be within 10 Pa of the pressure after being adjusted by a pressure measurement error estimate determined by the pressure measurement error function.

In accordance with some aspects, wherein the mathematical model is selected such that residual errors associated with the mathematical model and the plurality of different temperature and pressure combinations are each less than a threshold value of 10 Pa.

In accordance with some aspects, the mathematical model is selected when residual errors associated with the mathematical model and the plurality of different temperature and pressure combinations are less than corresponding residual errors associated with all other mathematical models of the plurality of mathematical models and the plurality of different temperature and pressure combinations.

In accordance with some aspects, methods described above are repeated for a second sensor, wherein the offset associated with the first sensor is different than the offset associated with the second sensor, and wherein the second sensor is the same model of sensor as the first sensor.

In accordance with some aspects, methods described above are repeated for a second sensor using the same mathematical model selected for the first sensor but with different parameters, and wherein the second sensor is the same model of sensor as the first sensor.

In accordance with some aspects, methods described above are repeated for a second sensor using a different mathematical model than the mathematical model selected for the first sensor, and wherein the second sensor is the same model of sensor as the first sensor.

In accordance with some aspects, methods described above are repeated for a second sensor, wherein the offset associated with the first sensor is different than the offset associated with the second sensor, and wherein the second sensor is a different model of sensor than the first sensor.

In accordance with some aspects, methods described above are repeated for a second sensor using the same mathematical model selected for the first sensor but with different parameters, and wherein the second sensor is a different model of sensor than the first sensor.

In accordance with some aspects, methods described above are repeated for a second sensor using a different mathematical model than the mathematical model selected for the first sensor, and wherein the second sensor is a different model of sensor than the first sensor.

In accordance with some aspects, the mathematical model defines a first mathematical model related to a first subset of the plurality of temperature and pressure combinations corresponding to a first sub-range of temperatures from the range of temperatures and a first sub-range of pressures from the range of pressures, and further defines a second mathematical model related to a second subset of the plurality of temperature and pressure combinations corresponding to a second sub-range of temperatures from the range of temperatures and a second sub-range of pressures from the range of pressures.

In accordance with some aspects, the plurality of different temperature and pressure combinations includes at least 4 different temperature and pressure combinations, wherein the temperature range includes temperatures between 0 and 60 degrees Celsius, and wherein the pressure range includes pressures between 72,000 and 107,000 Pa.

By way of example, method(s) and processor(s) may also or alternatively: receive a reported pressure measurement from a pressure sensor.

By way of example, method(s) and processor(s) may also or alternatively: estimate a pressure measurement error by solving a pressure measurement error function using the reported pressure measurement as an input. In accordance with some aspects, the pressure measurement error function is based on a mathematical model fitted to a plurality of pressure measurement errors that each relate to a respective difference between a reported measurement of pressure from the pressure sensor after the pressure sensor stabilized to a respective combination of temperature and pressure, and a calibrated measurement of the pressure from that respective combination.

By way of example, method(s) and processor(s) may also or alternatively: obtaining an adjusted pressure measurement for use in determining an altitude of the first sensor by adjusting the reported pressure measurement by the estimated pressure measurement error.

In accordance with some aspects, the pressure measurement error function is further based on a pressure measurement error offset that relates to a difference between a modeled pressure measurement error and a control pressure measurement error.

In accordance with some aspects, the control pressure measurement error is based on a difference between another reported measurement of pressure from the pressure sensor after having stabilized to a control temperature and a control pressure, and a calibrated measurement of the control pressure.

In accordance with some aspects, the modeled pressure measurement error is determined by inputting, into the mathematical model, a measurement of the control temperature and the reported measurement of the control pressure.

In accordance with some aspects, the plurality of different temperature and pressure combinations are selected so that any reported pressure measurement from the first sensor at a temperature within the temperature range and a pressure within the pressure range will be within 10 Pa of the pressure after being adjusted by a pressure measurement error determined by the pressure measurement error function.

In accordance with some aspects, the mathematical model is selected such that residual errors associated with the mathematical model and the plurality of different temperature and pressure combinations are each less than a threshold value of 10 Pa

In accordance with some aspects, the mathematical model is selected when residual errors associated with the mathematical model and the plurality of different temperature and pressure combinations are less than corresponding residual errors associated with all other mathematical models of the plurality of mathematical models and the plurality of different temperature and pressure combinations

In accordance with some aspects, the mathematical model defines a first mathematical model related to a first subset of the plurality of temperature and pressure combinations corresponding to a first sub-range of temperatures from the range of temperatures and a first sub-range of pressures from the range of pressures, and further defines a second mathematical model related to a second subset of the plurality of temperature and pressure combinations corresponding to a second sub-range of temperatures from the range of temperatures and a second sub-range of pressures from the range of pressures.

Systems may include any or all of: various sensors described herein and known in the art; one or more receivers at which position information is received and used to compute a position of the respective receiver; one or more servers at which position information is received and used to compute a position of a receiver; both receivers and servers; or other components.

An output from one system may cause another system to perform a method even if intervening steps occur between the output and performance of the method.

Any method step or feature disclosed herein may be expressly restricted from a claim for various reasons like achieving reduced manufacturing costs, lower power consumption, and increased processing efficiency.

The illustrative methods described herein may be implemented, performed, or otherwise controlled by suitable hardware known or later-developed by one of ordinary skill in the art, or by firmware or software executed by processor(s), or any combination of hardware, software and firmware. Software may be downloadable and non-downloadable at a particular system. Such software comprises a machine-implemented component that, once loaded on a machine like a processor or a computer, changes the operation of that machine.

Systems on which methods described herein are performed may include one or more means that implement those methods. For example, such means may include processor(s) or other hardware that, when executing instructions (e.g., embodied in software or firmware), perform any method step disclosed herein. A processor may include, or be included within, a computer or computing device, a controller, an integrated circuit, a “chip”, a system on a chip, a server, other programmable logic devices, other circuitry, or any combination thereof.

“Memory” may be accessible by a machine (e.g., a processor), such that the machine can read/write information from/to the memory. Memory may be integral with or separate from the machine. Memory may include a non-transitory machine-readable medium having machine-readable program code (e.g., instructions) embodied therein that is adapted to be executed to implement each of the methods and method steps disclosed herein. Memory may include any available storage media, including removable, non-removable, volatile, and non-volatile media—e.g., integrated circuit media, magnetic storage media, optical storage media, or any other computer data storage media. As used herein, machine-readable media includes all forms of machine-readable media except to the extent that such media is deemed to be non-statutory (e.g., transitory propagating signals).

Application programs may carry out aspects by receiving, converting, processing, storing, retrieving, transferring and/or exporting data, which may be stored in a hierarchical, network, relational, non-relational, object-oriented, or other data source. A data source may be a single storage device or realized by multiple (e.g., distributed) storage devices.

All of the information disclosed herein may be represented by data, and that data may be transmitted over any communication pathway using any protocol, stored on a data source, and processed by a processor. For example, transmission of data may be carried out using a variety of wires, cables, radio signals and infrared light beams, and an even greater variety of connectors, plugs and protocols even if not shown or explicitly described. Systems/platforms described herein may exchange information with each other (and with other systems that are not described) using any known or later-developed communication technology, including WiFi, Bluetooth, NFC and other communication network technologies. Carrier waves may be used to transfer data and instructions through electronic, optical, air, electromagnetic, radio frequency, or other signaling media over a network using network transfer protocols, including data that is transferred in data signals. Data, instructions, commands, information, signals, bits, symbols, and chips disclosed herein may be represented by voltages, currents, electromagnetic waves, magnetic fields or particles, optical fields or particles, or any combination thereof.

Different systems disclosed herein may be geographically dispersed from one another in different regions (e.g., cities, countries), such that different method steps are performed in different regions and by different systems.

Features in system figures that are illustrated as rectangles may refer to hardware, firmware or software, each of which may comprise a component of a device. It is noted that lines linking two such features may be illustrative of data transfer between those features. Such transfer may occur directly between those features or through intermediate features even if not illustrated. Where no line connects two features, transfer of data between those features is contemplated unless otherwise stated. Thus, such lines are provided to illustrate certain aspects, but should not be interpreted as limiting. The words comprise, comprising, include, including and the like are to be construed in an inclusive sense (i.e., not limited to) as opposed to an exclusive sense (i.e., consisting only of). Words using the singular or plural number also include the plural or singular number, respectively. The words or or and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment. This disclosure is not intended to be limited to the aspects shown herein but is to be accorded the widest scope understood by a skilled artisan, including equivalents.

A user device may be in the form of a cellular or smart phone, a tablet device, a PDA, a notebook, a digital camera, an asset tracking tag, an ankle bracelet or other device.

Certain aspects disclosed herein relate to a positioning system that estimates the positions of things—e.g., where the position is represented in terms of: latitude, longitude and/or altitude coordinates; x, y and/or z coordinates; angular coordinates; or other representations known by one of skill in the art. Positioning systems use various techniques to estimate the position of a thing (e.g., a receiver), including trilateration, which is the process of using geometry to estimate the position using distances traveled by different “ranging” signals that are received by the receiver from different beacons (e.g., transmitters, satellites, antennas). If the transmission time and reception time of a ranging signal are known, then the difference between those times multiplied by speed of light would provide an estimate of the distance traveled by that ranging signal. These estimates of distance are often referred to as “range” measurements. When errors in the measured time(s) are present, a “range” measurement is typically referred to as a “pseudorange” measurement. Thus, a “pseudorange” measurement is a type of “range” measurement. Positioning systems and methods that estimate a position of a receiver based on signaling from beacons (e.g., transmitters and/or satellites) are described in co-assigned U.S. Pat. No. 8,130,141, issued Mar. 6, 2012, and U.S. patent application Ser. No. 13/296,067, filed Nov. 14, 2011, which are incorporated herein in their entirety and for all purposes, except where their content conflicts with the content of this disclosure.

### RELATED APPLICATIONS

This application relates to U.S. Patent Application Ser. No. 61/899,846, filed Nov. 4, 2013, entitled DETERMINING CALIBRATED MEASUREMENTS OF PRESSURE FOR DIFFERENT SENSORS, the content of which is hereby incorporated by reference herein in its entirety.

1. A computer-implemented method for calibrating a sensor based on different environmental conditions, the method comprising:
identifying operating parameters, wherein the operating parameters include a set of temperatures and a set of pressures;
for each of a plurality of different temperature and pressure combinations that use temperatures from the set of temperatures and pressures from the set of pressures,
identifying a reported measurement of pressure from a first sensor when the first sensor is stabilized to the temperature and the pressure of that combination, and
computing a pressure measurement error based on a comparison of a calibrated measurement of the pressure and the reported measurement;
selecting a mathematical model that fits the computed pressure measurement errors as a function of the reported measurement of pressure and a measurement of temperature corresponding to each of the temperature and pressure combinations; and
storing a pressure measurement error function based on the mathematical model for later use in adjusting pressure measurements from the first sensor.

2. The method of claim 1, wherein the method comprising:
identifying an additional reported measurement of pressure from the first sensor when the first sensor is stabilized to a control temperature and a control pressure;
computing a control pressure measurement error based on a comparison of the additional reported measurement and a calibrated measurement of the control pressure;
computing a modeled pressure measurement error based on the mathematical model using model inputs that are based on the reported measurement of the control pressure from the first sensor and a measurement of the control temperature;
determining a pressure measurement error offset based on a difference between the modeled pressure measurement error and the control pressure measurement error; and
wherein the pressure measurement error function is based further on the pressure measurement error offset.

3. The method of claim 1, wherein the plurality of different temperature and pressure combinations are selected so that any reported pressure measurement from the first sensor at a temperature within the set of temperatures and a pressure within the set of pressures will be within 10 Pa of the pressure after being adjusted by a pressure measurement error determined by the pressure measurement error function.

4. The method of claim 1, wherein the mathematical model is selected from a plurality of other mathematical models such that residual errors associated with the mathematical model are each less than a threshold value of 10 Pa.

5. The method of claim 1, wherein the mathematical model is selected from a plurality of other mathematical models when residual errors associated with the mathematical model are less than corresponding residual errors associated with all of the other mathematical models.

6. The method of claim 2, wherein the steps of claim 2 are repeated for a second sensor, wherein the offset associated with the first sensor is different than the offset associated with the second sensor, and wherein the second sensor is the same model of sensor as the first sensor.

7. The method of claim 1, wherein the steps of claim 1 are repeated for a second sensor using the same mathematical model selected for the first sensor but with a different fit of computed pressure measurement errors as a function of a reported measurement of pressure by the second sensor, and wherein the second sensor is the same model of sensor as the first sensor.

8. The method of claim 1, wherein the steps of claim 1 are repeated for a second sensor using a different mathematical model than the mathematical model selected for the first sensor, and wherein the second sensor is the same model of sensor as the first sensor.

9. The method of claim 2, wherein the steps of claim 2 are repeated for a second sensor, wherein the offset associated with the first sensor is different than the offset associated with the second sensor, and wherein the second sensor is a different model of sensor than the first sensor.

10. The method of claim 1, wherein the steps of claim 1 are repeated for a second sensor using the same mathematical model selected for the first sensor but with a different fit of computed pressure measurement errors as a function of a reported measurement of pressure by the second sensor, and wherein the second sensor is a different model of sensor than the first sensor.

11. The method of claim 1, wherein the steps of claim 1 are repeated for a second sensor using a different mathematical model than the mathematical model selected for the first sensor, and wherein the second sensor is a different model of sensor than the first sensor.

12. The method of claim 1, wherein the mathematical model defines a first model related to a first subset of the plurality of temperature and pressure combinations corresponding to a first subset of temperatures from the set of temperatures and a first subset of pressures from the set of pressures, and further defines a second model related to a second subset of the plurality of temperature and pressure combinations corresponding to a second subset of temperatures from the set of temperatures and a second subset of pressures from the set of pressures.

13. The method of claim 1, wherein the plurality of different temperature and pressure combinations includes at least 4 different temperature and pressure combinations, wherein the set of temperatures includes temperatures between 0 and 60 degrees Celsius, and wherein the set of pressures includes pressures between 72,000 and 107,000 Pa.

14. One or more processors that:
estimate a pressure measurement error using the pressure measurement error function of claim 1 using a reported pressure measurement from the first sensor as an input; and
obtaining an adjusted pressure measurement for use in determining an altitude of the first sensor by adjusting the reported pressure measurement by the estimated pressure measurement error.

15. A computer-implemented method for determining a pressure measurement error associated with a pressure sensor, the method comprising:
receiving a reported pressure measurement from a pressure sensor;
estimating a pressure measurement error by using the reported pressure measurement as an input into a pressure measurement error function using, wherein the pressure measurement error function is based on a mathematical model fitted to a plurality of pressure measurement errors that each relate to a respective difference between a reported measurement of pressure from the pressure sensor after the pressure sensor stabilized to a respective combination of temperature and pressure, and a calibrated measurement of the pressure from that respective combination; and
obtaining an adjusted pressure measurement for use in determining an altitude of the first sensor by adjusting the reported pressure measurement by the estimated pressure measurement error.

16. The method of claim 15, wherein the pressure measurement error function is further based on a pressure measurement error offset that relates to a difference between a modeled pressure measurement error and a control pressure measurement error, wherein the control pressure measurement error is based on a difference between another reported measurement of pressure from the pressure sensor after having stabilized to a control temperature and a control pressure, and a calibrated measurement of the control pressure, and wherein the modeled pressure measurement error is determined by inputting, into the mathematical model, a measurement of the control temperature and the reported measurement of the control pressure.

17. The method of claim 15, wherein the plurality of different temperature and pressure combinations are selected so that any reported pressure measurement from the first sensor at a temperature within a set of temperatures and a pressure within a set of pressures will be within 10 Pa of the pressure after being adjusted by a pressure measurement error determined by the pressure measurement error function.

18. The method of claim 15, wherein the mathematical model is used such that residual errors associated with the mathematical model are each less than a threshold value of 10 Pa.

19. The method of claim 15, wherein the mathematical model is selected from a plurality of mathematical models when residual errors associated with the mathematical model are less than corresponding residual errors associated with all other mathematical models of the plurality of mathematical models.

20. The method of claim 15, wherein the mathematical model defines a first model related to a first subset of the plurality of temperature and pressure combinations corresponding to a first subset of temperatures from a set of temperatures and a first subset of pressures from a set of pressures, and further defines a second model related to a second subset of the plurality of temperature and pressure combinations corresponding to a second subset of temperatures from the set of temperatures and a second subset of pressures from the set of pressures.
